(19) United States
(12) Patent Application Publication
(10) Pub. No.: US 2026/0161118 A1
(43) Pub. Date: Jun. 11, 2026

(54) BELT DEVICE AND IMAGE FORMING APPARATUS

(71) Applicants: Naoki TAKAI, Tokyo (JP); Kuniyori TAKANO, Tokyo (JP); Hiroshi MIZUSAWA, Tokyo (JP); Hiroki MATSUURA, Kanagawa (JP)

(72) Inventors: Naoki TAKAI, Tokyo (JP); Kuniyori TAKANO, Tokyo (JP); Hiroshi MIZUSAWA, Tokyo (JP); Hiroki MATSUURA, Kanagawa (JP)

(21) Appl. No.: 19/366,568

(22) Filed: Oct. 23, 2025

(30) Foreign Application Priority Data
Dec. 9, 2024 (JP) 2024-214084

(51) Int. Cl. G03G 15/16; G03G 15/01; G03G 21/16

(52) U.S. Cl. CPC G03G 15/1615; G03G 15/0136; G03G 15/0189; G03G 21/1647; G03G 2221/1654

(57) ABSTRACT

A belt device includes a belt, a relay, multiple rollers including a drive roller, a tension roller, and a backup roller, a housing, a slide plate, and an adjuster. The drive roller rotates to cause the belt to travel. The tension roller applies tension to the belt, the belt stretched between the drive roller and the tension roller. The backup roller is rotatably supported by the relay and contacts an inner circumferential surface of the belt at a contact position. The housing supports both ends of each of the multiple rollers in an axial direction. The slide plate is held by the housing, holds and fixes the relay at a fix position in a slide direction orthogonal to the axial direction, and is slidable, in the slide direction, to shift the contact position in the slide direction. The adjuster adjusts the fix position of the relay in the slide direction.

### CROSS-REFERENCE TO RELATED APPLICATION

This patent application is based on and claims priority pursuant to 35 U.S.C. § 119 (a) to Japanese Patent Application No. 2024-214084, filed on Dec. 9, 2024, in the Japan Patent Office, the entire disclosure of which is hereby incorporated by reference herein.

### BACKGROUND

### Technical Field

The present disclosure relates to a belt device including a belt such as an intermediate transfer belt, and an image forming apparatus, such as a copier, a printer, a facsimile machine, or a multifunction peripheral (MFP) having at least two of such capabilities, incorporating the belt device.

### Related Art

In an image forming apparatus such as a copying machine or a printer, an image forming apparatus is known in which a belt device is disposed to stretch and support a belt such as an intermediate transfer belt by a plurality of rollers and to cause the belt to travel in a specified direction. On the other hand, a technique is also known that corrects the belt deviation of the intermediate transfer belt by inclining a tension roller, which is one of a plurality of rollers that stretch and support the intermediate transfer belt, with respect to an axis direction.

### SUMMARY

The present disclosure described herein provides a belt device that includes a belt, a relay, multiple rollers including a drive roller, a tension roller, and a backup roller, a housing, a slide plate, and an adjuster. The drive roller rotates to cause the belt to travel. The tension roller applies tension to the belt, the belt stretched between the drive roller and the tension roller. The backup roller is rotatably supported by the relay and contacts an inner circumferential surface of the belt at a contact position. The housing supports both ends of each of the multiple rollers in an axial direction of the multiple rollers. The slide plate is held by the housing, holds and fixes the relay at a fix position in a slide direction orthogonal to the axial direction, and is slidable, in the slide direction, to shift the contact position in the slide direction. The adjuster adjusts the fix position of the relay in the slide direction.

The present disclosure described herein also provides an image forming apparatus that includes an apparatus body and the belt device attachable to and detachable from the apparatus body in the axial direction. The adjuster includes a screw. The housing has an opening through which the screw is operable in the axial direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus according to an embodiment of the present disclosure;

FIG. 2 is a diagram illustrating an image forming device of the image forming apparatus of FIG. 1;

FIG. 3A is a diagram illustrating an intermediate transfer belt device in a full-color mode;

FIG. 3B is a diagram illustrating the intermediate transfer belt device in a monochrome mode;

FIG. 4 is a top view of the intermediate transfer belt device;

FIG. 5 is a side view of the intermediate transfer belt device;

FIG. 6 is a schematic view of an intermediate transfer belt device according to a first modification;

FIG. 7 is a cross-sectional view illustrating a belt deviation corrector in an intermediate transfer belt device according to a second modification;

FIG. 8 is a side view illustrating one end of a tension roller in a width direction; and

FIGS. 9A and 9B are cross-sectional views illustrating an operation of correcting a belt deviation of the intermediate transfer belt.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. Identical reference numerals are assigned to identical or equivalent components and a description of those components may be simplified or omitted. As used herein, the singular forms “a,” “an,” and “the” are intended to include the plural forms as well, unless the context clearly indicates otherwise.

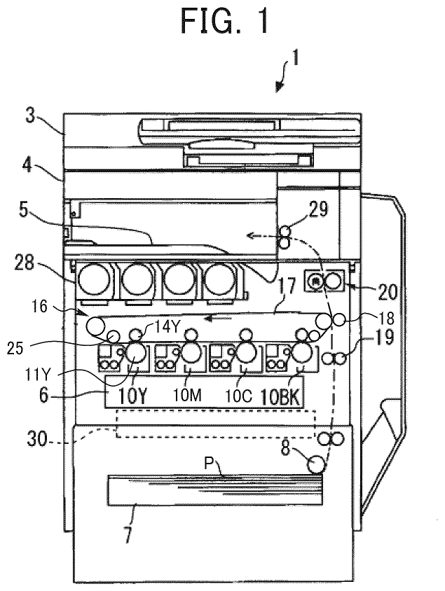

A description is given below of an overall configuration and operation of an image forming apparatus 1 with reference to FIG. 1. In FIG. 1, the image forming apparatus 1, which is illustrated as a color copier in the present embodiment, includes a document conveying device 3, a scanner 4 (document reading device), and a writing device 6 (exposure device). The document conveying device 3 conveys documents to the scanner 4. The scanner 4 scans the documents to read image data. The writing device 6 emits a laser beam based on input image data. The image forming apparatus 1 also includes a sheet feeder 7, process cartridges 10Y, 10M, 10C, and 10BK as image forming devices, an intermediate transfer belt device 16, and an intermediate transfer belt 17, a secondary transfer roller 18. The sheet feeder 7 stores sheets P such as sheets of paper. The process cartridges 10Y, 10M, 10C, and 10BK as image forming devices form toner images of yellow, magenta, cyan, and black, respectively. The intermediate transfer belt device 16 is a belt device in which the intermediate transfer belt 17 is disposed as a belt. The toner images of multiple colors are transferred and superimposed one on another onto the intermediate transfer belt 17. The secondary transfer roller 18 transfers the toner images on the intermediate transfer belt 17 onto the sheet P. The image forming apparatus 1 further includes a fixing device 20, toner containers 28, and a waste-toner collection container 30. The fixing device 20 fixes unfixed toner images on the sheet P. The toner containers 28 contain toners of respective colors to be supplied to developing devices 13 of the corresponding process cartridges 10Y, 10M, 10C, and 10BK (image forming devices). Waste-toner is collected in the waste-toner collection container 30.

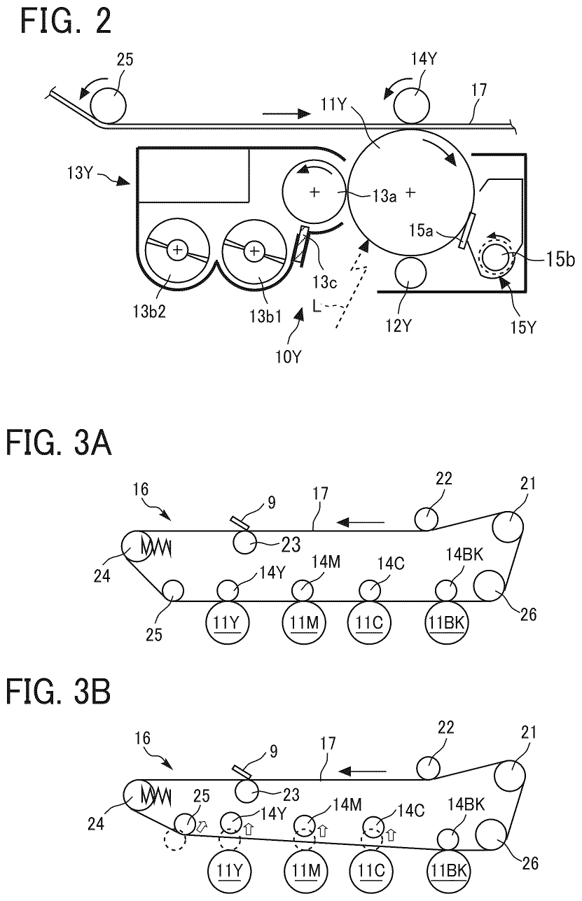

Each of the process cartridges 10Y, 10M, 10C, and 10BK (serving as image forming devices) includes a photoconductor drum 11Y (serving as an image bearer), a charging device 12Y, a developing device 13Y, and a cleaning device 15Y, which are united as a single unit as illustrated in FIG. 2. Each of the process cartridges 10Y, 10M, 10C, and 10BK, which is expendable, is replaced with a new one when depleted. Yellow, magenta, cyan, and black toner images are formed on the photoconductor drums 11Y, 11M, 11C, and 11BK (serving as image bearers) in the process cartridges 10Y, 10M, 10C, and 10BK, respectively.

A description is given below of operations of the image forming apparatus 1 to form a normal color toner image. Conveying rollers of the document conveying device 3 convey a document on a document table onto an exposure glass of the scanner 4. The scanner 4 optically scans the document on the exposure glass to read image data. The yellow, magenta, cyan, and black image data are transmitted to the writing device 6. The writing device 6 irradiates the photoconductor drums 11Y, 11M, 11C, and 11BK of the corresponding process cartridges 10Y, 10M, 10C, and 10BK with laser beams L (exposure light) based on the yellow, magenta, cyan, and black image data, respectively.

Each of the four photoconductor drums 11Y, 11M, 11C, and 11BK (see FIG. 3A) rotates clockwise in FIGS. 1, 2, 3A, and 3B. With reference to FIG. 2, a charging device 12Y (a charging roller) uniformly charges a surface of the photoconductor drum 11Y at a position opposite the photoconductor drum 11Y (a charging process). Thus, the surface of the photoconductor drum 11Y is charged to a charging potential. Subsequently, the surface of the photoconductor drum 11Y thus charged reaches a position where the surface of the photoconductor drum 11Y is irradiated with the laser beam L. The writing device 6 emits, from a light source, the laser beams L for respective colors according to the image data of respective colors. The laser beams L are reflected by a polygon mirror and transmitted through multiple lenses. The laser beams L transmitted through the multiple lenses pass through different optical passages for the different color components of yellow, magenta, cyan, and black (an exposure process).

The laser beam L corresponding to the yellow image data is emitted to the surface of the photoconductor drum 11Y in the first process cartridge 10Y from the left in FIG. 1, thus forming an electrostatic latent image corresponding to the yellow image data on the surface of the photoconductor drum 11Y. Thus, an electrostatic latent image corresponding to the image data of yellow is formed on the photoconductor drum 11Y charged by the charging device 12Y. The laser beam L corresponding to the magenta image data is emitted to the surface of the photoconductor drum 11M in the second process cartridge 10M from the left in FIG. 1, thus forming an electrostatic latent image corresponding to the magenta image data on the surface of the photoconductor drum 11M. The laser beam L corresponding to the cyan image data is emitted to the surface of the photoconductor drum 11C in the third process cartridge 10C from the left in FIG. 1, thus forming an electrostatic latent image corresponding to the cyan image data on the surface of the photoconductor drum 11C. The laser beam L corresponding to black image data is emitted to the surface of the photoconductor drum 11BK in the fourth process cartridge 10BK from the left in FIG. 1, thus forming an electrostatic latent image corresponding to the black image data on the surface of the photoconductor drum 11BK.

Then, the surface of the photoconductor drum 11Y bearing the electrostatic latent image for yellow color reaches the position opposite a developing device 13Y (see FIG. 2). The developing device 13Y supplies toner onto the surface of the photoconductor drum 11Y and develops the electrostatic latent image on the photoconductor drum 11Y into a toner image (a development process). Subsequently, the surface of the photoconductor drum 11Y after the development process reaches a position opposite the intermediate transfer belt 17 (an intermediate transferor) as the image bearer. A primary transfer roller 14Y is disposed at a position where the photoconductor drum 11Y faces the intermediate transfer belt 17 and contacts an inner circumferential surface of the intermediate transfer belt 17. At the position of the primary transfer rollers 14Y, 14M, 14C, and 14BK (see FIG. 3A), the toner images on the photoconductor drum 11Y, 11M, 11C, and 11BK are sequentially transferred to and superimposed on the intermediate transfer belt 17, forming a multicolor toner image thereon (a primary transfer process).

The surface of the photoconductor drum 11Y after the primary transfer process reaches a position facing the cleaning device 15Y (see FIG. 2). Then, untransferred toner remaining on the photoconductor drum 11Y is collected by the cleaning device 15Y (a cleaning process). Thereafter, the surface of the photoconductor drum 11Y passes through the position of a charge elimination device, and a series of image forming processes on the photoconductor drum 11Y is completed.

Meanwhile, the surface of the intermediate transfer belt 17, onto which the single-color toner images on the photoconductor drums 11Y, 11M, 11C, and 11BK are transferred and superimposed, moves in a direction indicated by an arrow in FIG. 1 and reaches a secondary transfer nip (a position where a secondary transfer roller 18 presses against the intermediate transfer belt 17). Then, at a position of the secondary transfer roller 18 (the secondary transfer nip), the full-color image on the intermediate transfer belt 17 is secondarily transferred onto the sheet P (a secondary transfer process). Thereafter, the surface of the intermediate transfer belt 17 reaches a position of an intermediate transfer cleaning device 9 (a cleaning device). As a result, the untransferred toner on the intermediate transfer belt 17 is collected by the intermediate transfer cleaning device 9, and a series of transfer processes on the intermediate transfer belt 17 is completed.

The sheet P is conveyed from a sheet feeder 7 to the position of the secondary transfer roller 18 via a conveyance guide, a registration roller pair 19. Specifically, a feed roller 8 feeds the sheet P from the sheet feeder 7 that stores a stack of sheets P, and the sheet P is then guided by the conveyance guide to the registration roller pair 19. The sheet P that has reached the registration roller pair 19 is conveyed toward the position of the secondary transfer roller 18 at a timing at which the sheet P can receive the multicolor toner image on the intermediate transfer belt 17.

Subsequently, the sheet P, onto which the multicolor toner image is transferred, is conveyed to a fixing device 20. The fixing device 20 includes a fixing roller and a pressure roller pressing against each other. In a nip between the fixing roller and the pressure roller, the multicolor toner image is fixed on the sheet P. After the fixing process, an output roller pair 29 ejects the sheet P as an output image to the exterior of a body of the image forming apparatus 1, and the ejected sheets P are stacked on an output tray 5 to complete a series of image forming processes.

Next, with reference to FIG. 2, image forming devices of the image forming apparatus 1 are described in detail below. FIG. 2 is a schematic view of the process cartridge 10Y for yellow. The other three process cartridges 10M, 10C, and 10BK have a similar configuration as the process cartridge 10Y for yellow except for the color of toner used in the image forming process, and thus drawings and descriptions thereof are omitted to avoid redundancy.

As illustrated in FIG. 2, the process cartridge 10Y includes the photoconductor drum 11Y as an image bearer, the charging device 12Y that charges the photoconductor drum 11Y, the developing device 13Y that develops electrostatic latent images formed on the photoconductor drum 11Y, and the cleaning device 15Y that collects the untransferred toner on the photoconductor drum 11Y, which are integrally stored in a case.

The photoconductor drum 11Y is an organic photoconductor designed to be charged with a negative polarity and includes a photosensitive layer formed on a drum-shaped conductive support. The charging device 12Y is a charging roller including a conductive core and an elastic layer of moderate resistivity overlaid on the outer circumference of the conductive core. A specified voltage is applied from a power supply to the charging device 12Y (the charging roller), so that the charging device 12Y uniformly charges the surface of the photoconductor drum 11Y facing the charging device 12Y.

The developing device 13Y includes a developing roller 13a disposed opposite the photoconductor drum 11Y, a first conveying screw 13b1 disposed opposite the developing roller 13a, a second conveying screw 13b2 disposed opposite the first conveying screw 13b1 via a partition, and a doctor blade 13c disposed opposite the developing roller 13a. The developing roller 13a includes multiple magnets and a sleeve that rotates around the magnets. The magnets are stationary and generate magnetic poles around the circumferential surface of the developing roller 13a. The magnets generate a plurality of magnetic poles on the developing roller 13a (sleeve) to bear developer on the developing roller 13a. The developing device 13Y stores two-component developer including carrier and toner.

The cleaning device 15Y includes a cleaning blade 15a that contacts the photoconductor drum 11Y and a conveying screw 15b that conveys the untransferred toner collected in the cleaning device 15Y toward a waste-toner conveyance passage. The cleaning blade 15a is made of a rubber material such as urethane rubber, and contacts the surface of the photoconductor drum 11Y at a specified angle and a specified pressure. With such a configuration, substances such as the untransferred toner adhering to the photoconductor drum 11Y are mechanically scraped off and collected in the cleaning device 15Y. The untransferred toner collected in the cleaning device 15Y is conveyed to the waste-toner conveyance passage via a conveying tube (in which a conveying screw 15b is disposed), and is finally collected as waste toner in a waste-toner collection container 30. Similarly, with reference to FIG. 3A, the intermediate transfer cleaning device 9 as a cleaning device also includes a cleaning blade that contacts the intermediate transfer belt 17 and a conveying screw that conveys the untransferred toner collected in the intermediate transfer cleaning device 9 toward the waste-toner conveyance passage. The untransferred toner collected in the intermediate transfer cleaning device 9 is conveyed to the waste-toner conveyance passage via a conveying tube (in which a conveying screw is disposed), and is finally collected as waste toner in the waste-toner collection container 30.

The image forming processes, described above, are described in further detail below with reference to FIG. 2. The developing roller 13a rotates in a direction (counterclockwise) indicated by an arrow in FIG. 2. In the developing device 13Y, as the first conveying screw 13b1 and the second conveying screw 13b2 arranged via the partition rotate, the developer is circulated in the longitudinal direction of the developing device 13, while being stirred and mixed with toner supplied from the toner container 28 by a toner supply device. The longitudinal direction of the developing device 13 is perpendicular to the plane on which FIG. 2 is illustrated.

Thus, the toner is triboelectrically charged and attracted to the carrier. The toner is borne on the developing roller 13a together with the carrier. The developer borne on the developing roller 13a reaches a position opposite the doctor blade 13c. The developer on the developing roller 13a is adjusted to an appropriate amount at the doctor blade 13c, and then is supplied to the position (developing region) facing the photoconductor drum 11Y. Thereafter, in the developing region, the toner in the developer adheres to the latent electrostatic image formed on the surface of the photoconductor drum 11Y. Specifically, the toner adheres to the electrostatic latent image (the toner image is formed) by a development electric field formed by a potential difference (a developing potential) between a latent image potential (an exposure potential) of an image area irradiated with the laser beam L and a development bias applied to the developing roller 13a. Thereafter, most of the toner adhering to the photoconductor drum 11Y in the development process is transferred onto the intermediate transfer belt 17. The untransferred toner remaining on the photoconductor drum 11Y is collected into the cleaning device 15Y by the cleaning blade 15a.

A detailed description is given below of the intermediate transfer belt device 16 as a belt device of the image forming apparatus 1 according to the present embodiment. With reference to FIG. 3A, the intermediate transfer belt device 16 as a belt device includes the intermediate transfer belt 17 as a belt, four primary transfer rollers 14Y, 14M, 14C, and 14BK, a drive roller 21, a pressing roller 22, a cleaning counter roller 23, a tension roller 24, a backup roller 25, a pre-transfer roller 26, and the intermediate transfer cleaning device 9.

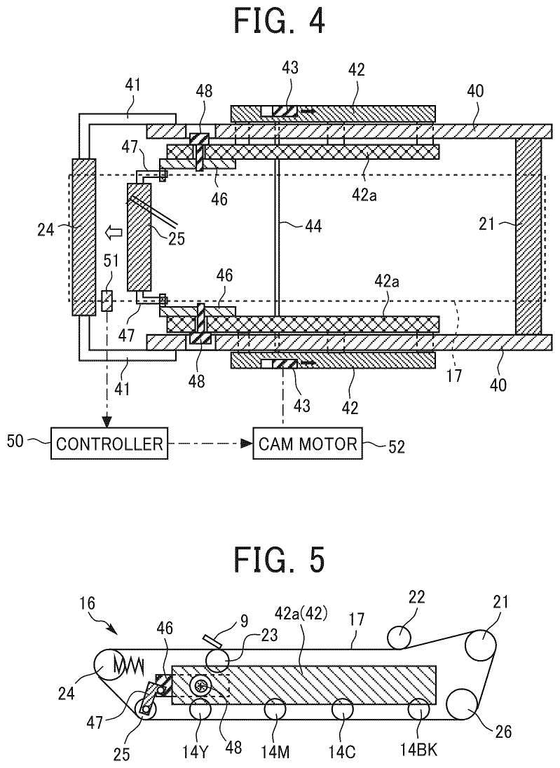

The intermediate transfer belt 17 as a belt is stretched and supported by a plurality of rollers 21, 22, 23, 24, 25, 26, 14Y, 14M, 14C, and 14BK. The plurality of rollers are arranged in the order of the drive roller 21, the pressing roller 22, the cleaning counter roller 23, the tension roller 24, the backup roller 25, the primary transfer rollers 14Y, 14M, 14C, 14BK, and the pre-transfer roller 26 along the traveling direction of the intermediate transfer belt 17 with the position of the secondary transfer nip as a reference. The rollers 21, 23, 24, 25, 26, 14Y, 14M, 14C, and 14BK other than the pressing roller 22 are in contact with the inner circumferential surface of the intermediate transfer belt 17. Both ends of each of the plurality of rollers 21, 22, 23, 24, 25, 26, 14Y, 14M, 14C, and 14BK are rotatably supported directly or indirectly by a housing 40 (see FIG. 4) of the intermediate transfer belt 17.

The drive roller 21 is one of a plurality of rollers, and is a roller that runs the intermediate transfer belt 17 (a belt). The intermediate transfer belt 17 is endlessly moved by the rotational driving of the drive roller 21 by a drive motor in the direction of the arrow in FIGS. 3A and 3B. The rollers 22, 23, 24, 25, 26, 14Y, 14M, 14C, and 14BK other than the drive roller 21 are driven to rotate along the travel of the intermediate transfer belt 17. The drive roller 21 contacts the secondary transfer roller 18 (see FIG. 1) via the intermediate transfer belt 17 to form a secondary transfer nip. In the present embodiment, the drive roller 21 is rotatably supported directly by the housing 40 as illustrated in FIG. 4.

The tension roller 24 is one of a plurality of rollers, and is a roller that applies a tension to the intermediate transfer belt 17 (a belt). The tension roller 24 is slidably held by a housing of the intermediate transfer belt device 16, and is biased by a compression spring as a biasing member to apply tension to the intermediate transfer belt 17 from the inner circumferential surface. In the present embodiment, as illustrated in FIG. 4, the tension roller 24 is rotatably supported indirectly by the housing 40 via a holder 41.

The backup roller 25 is one of a plurality of rollers, and as illustrated in FIGS. 4 and 5, ends of the backup roller 25 are rotatably supported indirectly by relays 46 via bearings 47. The relay 46 is adjustably held by a slide plate 42 (slidably held relative to the housing 40) described later. Accordingly, the backup roller 25 is rotatably supported indirectly by the housings 40 via the bearings 47 and the relays 46. The backup roller 25 changes the position where the backup roller 25 contacts the intermediate transfer belt 17 as the slide plate 42 slides, which is described in detail later with reference to FIGS. 3A and 3B. In the present embodiment, the backup roller 25 may be rotatably supported directly by the relays 46.

The pressing roller 22 is in contact with the outer circumferential surface of the intermediate transfer belt 17 on a downstream side of the secondary transfer nip. An optical sensor is disposed in the vicinity of the intermediate transfer belt 17 to face the outer circumferential surface of the intermediate transfer belt 17. The optical sensor optically detects the image density of the patch pattern formed on the surface of the intermediate transfer belt 17, so that the image forming conditions are adjusted based on the detection result. At this time, the traveling of the intermediate transfer belt 17 is stabilized by the pressing roller 22, so that the detection accuracy of the optical sensor is enhanced. The cleaning counter roller 23 is disposed to nip the intermediate transfer belt 17 between the cleaning counter roller 23 and the cleaning blade 15a of the intermediate transfer cleaning device 9. With such a configuration, cleaning performance of the intermediate transfer cleaning device 9 is enhanced. The pre-transfer roller 26 is in contact with the inner circumferential surface of the intermediate transfer belt 17 on an upstream side of the secondary transfer nip. The pre-transfer roller 26 facilitates the feeding of the sheet P into the secondary transfer nip.

The four primary transfer rollers 14Y, 14M, 14C, and 14BK are pressed against the corresponding photoconductor drums 11Y, 11M, 11C, and 11BK, respectively, via the intermediate transfer belt 17 to form primary transfer nips. A transfer voltage (a primary transfer bias) opposite in polarity to toner is applied to the primary transfer rollers 14Y, 14M, 14C, and 14BK. The intermediate transfer belt 17 travels in the direction (clockwise) indicated by an arrow in FIGS. 3A and 3B, and sequentially passes through the primary transfer nips of the primary transfer rollers 14Y, 14M, 14C, and 14BK. In this way, the toner images of the respective colors on the photoconductor drums 11Y, 11M, 11C, and 11BK are primarily transferred onto the intermediate transfer belt 17 in a superimposed manner (a primary transfer process).

The image forming apparatus 1 according to the present embodiment is switchable between a full-color mode as a first mode illustrated in FIG. 3A and a monochrome mode as a second mode illustrated in FIG. 3B. The switching between the full-color mode and the monochrome mode is performed so that a controller 50 controls the driving of a cam motor 52 that slides the slide plate 42 or controls a contact-and-separation mechanism that moves the three primary transfer rollers 14Y, 14M, and 14C for color up and down, based on the operation (print command) of an operation panel by a user.

With reference to FIG. 3A, the full-color mode as the first mode is a control mode in which the intermediate transfer belt 17 is caused to run by the drive roller 21 in a state where the intermediate transfer belt 17 (a belt) is stretched and supported by all of the plurality of rollers 21, 22, 23, 24, 25, 26, 14Y, 14M, 14C, and 14BK. The full-color mode (first mode) is executed based on an operation of the operation panel by a user when performing full-color printing using four colors (yellow, magenta, cyan, and black). In the full-color mode, the intermediate transfer belt 17 is sandwiched between all of the four photoconductor drums 11Y, 11M, 11C, and 11BK and the primary transfer rollers 14Y, 14M, 14C, and 14BK to form the four primary transfer nips.

On the other hand, with reference to FIG. 3B, the monochrome mode as the second mode is a control mode in which at least one roller (in the present embodiment, three primary transfer rollers 14Y, 14M, and 14C for color) among the plurality of rollers 21, 22, 23, 24, 25, 26, 14Y, 14M, 14C, and 14BK excluding the drive roller 21, the tension roller 24, and the backup roller 25 is separated from the intermediate transfer belt 17, and in a state where the intermediate transfer belt 17 is stretched and supported by the remaining rollers 21, 22, 23, 24, 25, 26, and 14BK, the intermediate transfer belt 17 is caused to travel by the drive roller 21. The monochrome mode (second mode) is executed based on an operation of the operation panel by a user when monochrome printing is performed using only black toner. In the monochrome mode, only the photoconductor drum 11BK for black sandwiches the intermediate transfer belt 17 with the primary transfer roller 14BK for black to form one primary transfer nip. On the other hand, the three color photoconductor drums 11Y, 11M, and 11C and the three primary transfer rollers 14Y, 14M, and 14C corresponding thereto are separated from the intermediate transfer belt 17 not to contact the intermediate transfer belt 17 uselessly.

With reference to FIGS. 4 and 5, the intermediate transfer belt device 16 includes the slide plate 42 that is held slidably with respect to the housing 40 and holds the relay 46 that supports the backup roller 25. Specifically, in the present embodiment, the slide plates 42 are respectively installed at both ends in the width direction along the surface of the housing 40. Cams 43 installed in the respective concave portions are coupled by a rod 44. The cams 43 are connected to the cam motor 52. The slide plates 42 are moved in the left direction and the right direction in FIGS. 4 and 5 by controlling the rotation of the cam motor 52 by the controller 50. The slide plate 42 is provided with a guide 42a. The relays 46 are fixed and held to the guides 42a by screw fastening with adjusting screws 48 described later. The relay 46 also functions as a reinforcing member that reinforces the slide plate 42 (guide 42a). When the slide plates 42 slide in the left-and-right directions in FIGS. 4 and 5, the relays 46 also move in the same direction, and the backup roller 25 supported via the bearings 47 also moves from the position illustrated in FIG. 3A (or FIG. 3B) to the position illustrated in FIG. 3B (or FIG. 3A). In other words, with reference to FIGS. 3A, 3B, and 5, the slide plates 42 slide with respect to the housings 40 to change the position where the backup roller 25 contacts the inner circumferential surface of the intermediate transfer belt 17 in a cross-section orthogonal to the axis direction. In other words, the slide plates 42 slide with respect to the housings 40 to change the contact state of the backup roller 25 with the inner circumferential surface of the intermediate transfer belt 17 (to change the contact position).

The sliding movement of the slide plate 42 (displacement of the backup roller 25) is automatically performed by the control of the cam motor 52 by the controller 50 when the switching between the full-color mode (first mode) and the monochrome mode (second mode) described above with reference to FIGS. 3A and 3B is performed. As a result, the attitude of the intermediate transfer belt 17 during the operation in the full-color mode illustrated in FIG. 3A and the attitude of the intermediate transfer belt 17 during the operation in the monochromatic mode illustrated in FIG. 3B are preferably maintained.

As illustrated in FIGS. 4 and 5, the intermediate transfer belt device 16 according to the present embodiment includes the adjusting screws 48 as adjusters that can manually adjust the fixing positions of the relays 46 fixed and held on the slide plates 42 (guides 42a). Specifically, the guide 42a of the slide plate 42a has a through hole sufficiently larger than the screw diameter of the adjusting screw 48. The relay 46 has a female screw portion into which the adjusting screw 48 can be screwed. Accordingly, in a state where the adjusting screw 48 (adjuster) is loosened, the relative position of the relay 46 with respect to the slide plate 42 (guide 42a) is adjusted, and the adjusting screw 48 is fastened at the adjusted position to fix the relay 46. In the present embodiment, the intermediate transfer belt device 16 is provided with the slide plate 42 and the relay 46 at each of both ends in the width direction, and one adjusting screw 48 is disposed at each of the ends of the slide plate 42 and the relay 46. As a result, the relay 46 can be adjusted in multiple directions with respect to the slide plate 42. On the other hand, in a case where the relay 46 is adjusted only in one direction (for example, the horizontal direction) with respect to the slide plate 42, a plurality of adjusting screws 48 may be installed.

As described above, in the present embodiment, the position of the relay 46 with respect to the slide plate 42 is adjustable. It is possible to adjust the position of the relay 46 so that the intermediate transfer belt 17 is less likely to be shifted, regardless of the dimensional accuracy, the assembly accuracy, and the deformation of the plurality of rollers 21, 22, 23, 24, 25, 26, 14Y, 14M, 14C, and 14BK, the housing 40, and other components that stretch and support the intermediate transfer belt 17. In particular, in the intermediate transfer belt device 16 according to the present embodiment, the plurality of rollers 21, 22, 23, 24, 25, 26, 14Y, 14M, 14C, and 14BK that stretch and support the intermediate transfer belt 17 include a roller (backup roller 25) that varies the contact position with respect to the intermediate transfer belt 17. The reaction force received by the backup roller 25 from the intermediate transfer belt 17 is large in the full-color mode and in the monochrome mode, so that deformation such as torsion is likely to occur in the frame body such as the housing 40. As a result, the parallelism of the plurality of rollers 21, 22, 23, 24, 25, 26, 14Y, 14M, 14C, and 14BK is deteriorated, and the belt deviation of the intermediate transfer belt 17 is likely to occur, so that it is useful that the position of the relay 46 with respect to the slide plate 42 is adjustable.

In the present embodiment, as illustrated in FIG. 3B, among the plurality of rollers 21, 22, 23, 24, 25, 26, 14Y, 14M, 14C, and 14BK, the tension roller 24, the backup roller 25, and the primary transfer rollers 14Y, 14M, and 14C for color (at least one roller that moves away in the monochrome mode) are arranged along the traveling direction of the intermediate transfer belt 17. Accordingly, the backup roller 25 is a roller that receives the largest tension (reaction force) from the intermediate transfer belt 17 when the mode is switched between the full-color mode and the monochrome mode. Thus, the position of the relay 46 is adjusted with respect to the slide plate 42 to displace the backup roller 25, so that the effect of correcting the belt deviation of the intermediate transfer belt 17 is more easily exhibited compared to displacing other rollers.

The intermediate transfer belt device 16 (belt device) according to the present embodiment is detachably attached to the body of the image forming apparatus 1 in an axis direction as an attachment-and-detachment direction (a vertical direction in FIG. 4 and a direction perpendicular to the plane on which FIGS. 1 and 5 are illustrated). Specifically, in FIG. 4, the intermediate transfer belt device 16 is pulled out from the upper side to the lower side with respect to the body of the image forming apparatus 1, and is attached from the lower side to the upper side. The adjusting screw 48 as the adjuster (particularly, the adjusting screw 48 disposed on the lower side in FIG. 4) is manually operable from the front side in the attachment direction (the lower side in FIG. 4 and the upstream side in the attachment direction) with respect to the intermediate transfer belt device 16 attached in the body of the image forming apparatus 1. An opening for approaching the adjusting screw 48 is formed in the housing 40 to enable such manual operation. With such a configuration, the adjusting screw 48 can be manually operated without taking out the intermediate transfer belt device 16 from the body of the image forming apparatus 1, so that the efficiency of the adjustment operation is enhanced. The adjusting screw 48 is difficult to be manually operated in a state where the intermediate transfer belt device 16 is attached to the body of the image forming apparatus 1. When the belt deviation is not sufficiently corrected by adjusting the adjusting screw 48 on the lower side in FIG. 4, the adjusting screw 48 is manually operated in a state where the intermediate transfer belt device 16 is pulled out from the body of the image forming apparatus 1.

With reference to FIG. 4, the intermediate transfer belt device 16 according to present embodiment includes a belt deviation detection sensor 51 as a detector that detects a deviation amount of the intermediate transfer belt 17 (belt) with respect to an axis direction (up-and-down direction in FIG. 4). Specifically, the belt deviation detection sensor 51 (detector) includes, for example, a plurality of photosensors arranged in parallel in the axis direction, and optically detects the position of an end in the axis direction (end in the width direction) of the intermediate transfer belt 17 to detect the belt deviation amount (including the deviation direction). The slide plate 42 is automatically slid and moved so that the belt deviation is corrected in accordance with a detection result of the belt deviation detection sensor 51 (detector). Specifically, when the belt deviation detection sensor 51 detects a specified amount of belt deviation toward one end in the width direction, the slide plate 42 is slid to change the balance of the tension of the backup roller 25 so that the specified amount of belt deviation is corrected. Such a configuration can automatically correct the belt deviation with high responsiveness, even a relatively small belt deviation that cannot be corrected by manual adjustment of the adjusting screw 48. In particular, in the present embodiment, the belt deviation detection sensor 51 is disposed in the vicinity of the backup roller 25, so that the responsiveness of the belt deviation correction can be enhanced.

### First Modification

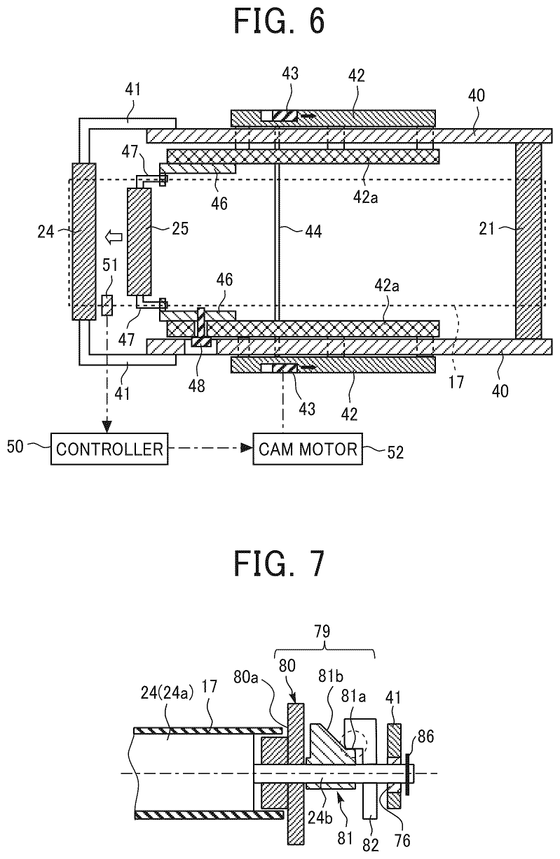

As illustrated in FIG. 6, in the intermediate transfer belt device 16 according to the first modification, the adjuster (adjusting screw 48) is not disposed on each of both sides in the width direction (axis direction), but is disposed only on one side in the width direction (on the front side in the attachment direction of the intermediate transfer belt device 16). Such a configuration is useful in a case where the belt deviation correction can be sufficiently performed only by adjusting the adjusting screw 48 on one side in the width direction.

### Second Modification

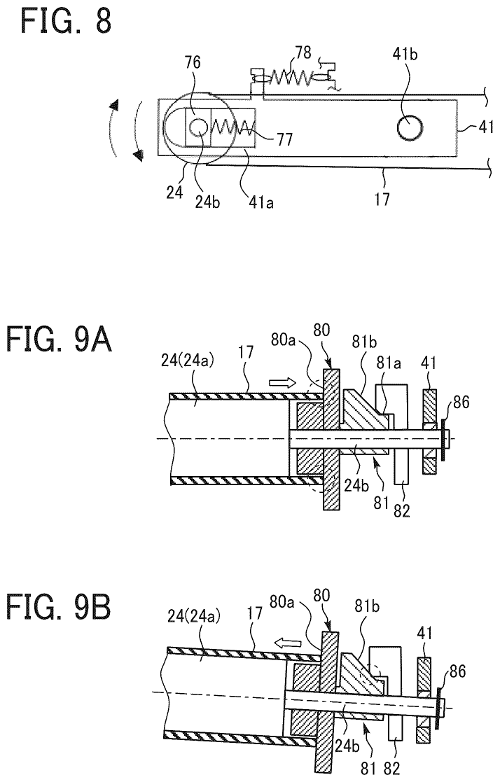

As illustrated in FIGS. 7, 8, 9A, and 9B, the intermediate transfer belt device 16 according to the second modification includes a belt deviation corrector 79 that corrects the deviation of the intermediate transfer belt 17 (belt) in the axis direction (width direction) by inclining the tension roller 24 with respect to the axis direction (the direction perpendicular to the plane on which FIGS. 3A, 3B, 5, and 8 are is illustrated, the up-and-down direction in FIG. 4, and the left-and-right direction in FIGS. 7, 9A, and 9B). The belt deviation corrector 79 inclines the tension roller 24 in conjunction with the movement of the intermediate transfer belt 17 in the width direction to correct the deviation of the intermediate transfer belt 17. Specifically, as illustrated in FIG. 7, the tension roller 24 includes a roller portion 24a that contacts the inner circumferential surface of the intermediate transfer belt 17, and a shaft portion 24b (roller shaft) that has an outer diameter smaller than the outer diameter of the roller portion 24a and protrudes from both ends of the roller portion 24a. The two shaft portions 24b may protrude separately from both ends of the roller portion 24a, or one shaft portion 24b may penetrates through the roller portion 24a to protrude from both ends. In any case, the tension roller 24 in the present embodiment is formed such that the roller portion 24a and the shaft portion 24b are united with each other, and thus, the roller portion 24a and the shaft portion 24b rotate united with each other. As illustrated in FIG. 7, the holder 41 of the intermediate transfer belt device 16 includes a bearing 76 that receives the shaft portion 24b of the tension roller 24. In other words, the shaft portions 24b at both ends of the tension roller 24 are rotatably held by the holders 41 (see FIG. 8) functioning as swing plates via the bearings 76. The holder 41 (swing plate) is held by the housing 40 to be rotatable in the arrow direction in FIG. 8 around a support shaft 41b together with the tension roller 24. The holder 41 is biased in the clockwise direction in FIG. 8 by a tension spring 78 connected between the holder 41 and the housing 40. The shaft portions 24b of the tension roller 24 are rotatably held by guide holes 41a of the holders 41 at both ends of the tension roller 24 via the bearings 76. The bearing 76 is slidably held by the guide hole 41a and is biased leftward in FIG. 8 by a compression spring 77. With such a configuration, the tension roller 24 is pressed against the inner circumferential surface of the intermediate transfer belt 17 by the biasing force of the compression springs 77, and applies tension to the intermediate transfer belt 17.

As illustrated in FIGS. 7, 9A, and 9B, the belt deviation corrector 79 includes a flange 80, a sliding member 81, and a contact member 82. The sliding member 81 is slidably supported by the shaft portion 24b of the tension roller 24, and inclines the tension roller 24 (shaft portion 24b) in conjunction with the operation (belt deviation) in which the intermediate transfer belt 17 moves in the width direction (left-and-right direction in FIGS. 7, 9A, and 9B). The sliding member 81 has a parallel surface 81a parallel to the rotation axis direction and an inclined surface 81b inclined with respect to the parallel surface 81a. The contact member 82 contacts the parallel surface 81a and the inclined surface 81b. The sliding member 81 does not rotate with the running of the intermediate transfer belt 17 and the rotation of the tension roller 24 (shaft portion 24b). Specifically, the sliding member 81 is locked to a projection for rotation stop formed on the housing 40 of the image forming apparatus, and the rotation of the tension roller 24 is restricted. The contact member 82 is contactable against the parallel surface 81a and the inclined surface 81b of the sliding member 81. The tension roller 24 (shaft portion 24b) is inclined by sliding of the inclined surface 81b of the sliding member 81 and the contact member 82 in conjunction with the operation of the intermediate transfer belt 17 moving in the width direction. The flange 80 is disposed to be contactable to the end surface of the intermediate transfer belt 17, and is pushed and moved by the intermediate transfer belt 17 as the intermediate transfer belt 17 moves in the width direction. The flange 80 is rotatable (rotatable together) with the running of the intermediate transfer belt 17 and the rotation of the tension roller 24 (shaft portion 24b). The sliding member 81 is disposed to be contactable to the flange 80 at a position opposite to the intermediate transfer belt 17. The belt deviation corrector 79 having such a configuration corrects the belt deviation of the intermediate transfer belt 17 (belt movement in the left-and-right direction in FIGS. 7, 9A, and 9B). Specifically, when the intermediate transfer belt 17 is shifted to the right, as illustrated in FIG. 9A, the end surface of the intermediate transfer belt 17 contacts a contact portion 80a of the flange 80, and thus, the flange 80 slides to the right to push the sliding member 81 to the right. When the sliding member 81 is pushed to the right, the contact member 82 that has been in contact with the parallel surface 81a as illustrated in FIG. 9A comes into contact with the inclined surface 81b as illustrated in FIG. 9B, so that the tension roller 24 is inclined along the inclination of the inclined surface 81b as illustrated in FIG. 9B. As illustrated in FIG. 9B, when the right end of the tension roller 24 is inclined, the intermediate transfer belt 17 is inclined leftward as viewed from the tension roller 24. When the intermediate transfer belt 17 moves by a distance Y, the intermediate transfer belt 17 is shifted leftward, and the belt shift to the right is canceled. As a result, the belt deviation of the intermediate transfer belt 17 is corrected by the belt deviation corrector 79. The belt deviation corrector 79 having such a configuration as described above is added to the intermediate transfer belt device 16 described with reference to FIGS. 3A, 3B, and 5, so that the intermediate transfer belt 17 is further less likely to deviate. Although not illustrated in FIGS. 8, 9A, and 9B, in the present embodiment, the belt deviation corrector 79 is disposed not only on one end in the width direction (lower side in FIG. 8), but also on the other end in the width direction (upper side in FIG. 8).

As described above, the intermediate transfer belt device 16 (belt device) according to the present embodiment includes the intermediate transfer belt 17 (belt member) stretched and supported by the plurality of rollers 21, 22, 23, 24, 25, 26, 14Y, 14M, 14C, and 14BK, the drive roller 21 that is one of the plurality of rollers and causes the intermediate transfer belt 17 to travel, the tension roller 24 that is one of the plurality of rollers and applies the tension to the intermediate transfer belt 17, and the backup roller 25 that is one of the plurality of rollers and has an end directly or indirectly rotatably supported by the relay 46. The housing 40 is disposed to directly or indirectly support both ends of the plurality of rollers 21, 22, 23, 24, 25, 26, 14Y, 14M, 14C, and 14BK in a rotatable manner. The intermediate transfer belt device 16 further includes a slide plate 42 that is slidably held by the housing 40, holds the relay 46, and slides relative to the housing 40 to change the position where the backup roller contacts the inner circumferential surface of the intermediate transfer belt 17 viewed in a cross-section orthogonal to the axis direction. The adjusting screw 48 (adjuster) is disposed that can manually adjust the fixing position of the relay 46 fixed and held on the slide plate 42. As a result, the intermediate transfer belt 17 is less likely to cause the belt deviation.

In the present embodiment, the present disclosure is applied to the intermediate transfer belt device 16 as a belt device, but the present disclosure can be applied to other belt devices (for example, a secondary transfer belt device in which a secondary transfer belt is installed as a belt). In such a case, in the present embodiment, the full color mode is used as the first mode and the monochrome mode is used as the second mode, but other modes can be used as the first mode and the second mode. In addition, in the present embodiment, the adjuster (adjusting screw 48) is disposed at a position where the adjuster can be manually operated from the front side in the attachment direction. However, the adjuster (adjusting screw 48) can also be disposed at other positions (for example, a position where the adjuster can be manually operated from the left side in FIG. 4). Such cases can also provide substantially the same or similar effects as the effects described above.

A belt device includes a belt, a relay, multiple rollers including a drive roller, a tension roller, and a backup roller, a housing, a slide plate, and an adjuster. The drive roller rotates to cause the belt to travel. The tension roller applies tension to the belt, the belt stretched between the drive roller and the tension roller. The backup roller is rotatably supported by the relay and contacts an inner circumferential surface of the belt at a contact position. The housing supports both ends of each of the multiple rollers in an axial direction of the multiple rollers. The slide plate is held by the housing, holds and fixes the relay at a fix position in a slide direction orthogonal to the axial direction, and is slidable, in the slide direction, to shift the contact position in the slide direction. The adjuster adjusts the fix position of the relay in the slide direction.

The belt device further includes circuitry that controls the multiple rollers. The multiple rollers further include multiple transfer rollers to transfer images to the belt. The circuitry causes all the multiple transfer rollers to contact the inner circumferential surface of the belt and drives the drive roller to cause the belt to travel, to perform a first mode. The circuitry causes at least one of the multiple transfer rollers to be separated from the inner circumferential surface of the belt, causes the multiple transfer rollers other than the at least one of the multiple transfer rollers to contact the inner circumferential surface of the belt, and drives the drive roller to cause the belt to travel, to perform a second mode. The circuitry switches between the first mode and the second mode and causes the slide plate to slide in response to a switch between the first mode and the second mode.

The multiple rollers include the tension roller, the backup roller, and the at least one of the multiple transfer rollers, and are arranged in this order along a travel direction of the belt.

The belt device further includes a belt deviation corrector to incline the tension roller with respect to the axial direction to correct a deviation of the belt in the axial direction.

The belt device further includes a detector to detect an amount of deviation of the belt in the axial direction. The circuitry further configured to cause the slide plate to slide in the slide direction according to the amount of deviation detected by the detector.

An image forming apparatus includes an apparatus body and the belt device attachable to and detachable from the apparatus body in the axial direction. The adjuster includes a screw. The housing has an opening through which the screw is operable in the axial direction.

Note that embodiments of the present disclosure are not limited to the above-described embodiments and it is apparent that the above-described embodiments can be appropriately modified within the scope of the technical idea of the present embodiment in addition to what is suggested in the above-described embodiments. Further, features of components of the embodiments, such as the number, the position, and the shape are not limited the embodiments and thus may be preferably set.

Aspects of the present disclosure may be, for example, combinations of first to seventh aspects as follows.

### First Aspect

A belt device (e.g., the intermediate transfer belt device 16) includes a belt (e.g., the intermediate transfer belt 17), a drive roller (e.g., the drive roller 21), a tension roller (e.g., the tension roller 24), a backup roller (e.g., the backup roller 25), a housing (e.g., the housing 40), a slide plate (e.g., the slide plate 42), and an adjuster (e.g., the adjusting screw 48). The belt is stretched and supported by a plurality of rollers. The drive roller is one of the plurality of rollers and causes the belt to travel. The tension roller is one of the plurality of rollers and applies tension to the belt. The backup roller is one of the plurality of rollers, and an end of the backup roller is rotatably supported directly or indirectly by a relay (e.g., the relay 46). The housing directly or indirectly supports both ends of the plurality of rollers such that the plurality of rollers are rotatable. The slide plate is slidably held with respect to the housing, and holds the relay and slides with respect to the housing so that the slide plate changes a position where the backup roller contacts an inner circumferential surface of the belt in a cross-section orthogonal to an axis direction. The adjuster can manually adjust a fixed position of the relay fixed and held to the slide plate.

### Second Aspect

In the belt device (e.g., the intermediate transfer belt device 16) according to the first aspect, the belt device is switchable between a first mode in which the belt (e.g., the intermediate transfer belt 17) is caused to travel by the drive roller (e.g., the drive roller 21) in a state where the belt is stretched and supported by all of the plurality of rollers and a second mode in which the belt is caused to travel by the drive roller in a state where at least one roller other than the drive roller, the tension roller (e.g., the tension roller 24), and the backup roller (e.g., the backup roller 25) among the plurality of rollers is separated from the belt and the belt member is stretched and supported by the remaining rollers. A slide movement of the slide plate (e.g., the slide plate 42) is automatically performed when the first mode and the second mode are switched.

### Third Aspect

In the belt device (e.g., the intermediate transfer belt device 16) according to the second aspect, the tension roller (e.g., the tension roller 24), the backup roller (e.g., the backup roller 25), and at least one roller among the plurality of rollers are arranged along a traveling direction of the belt (e.g., the intermediate transfer belt 17).

### Fourth Aspect

In the belt device (e.g., the intermediate transfer belt device 16) according to any one of the first to third aspects, the belt device is removably installed in a body of an image forming apparatus (e.g., the image forming apparatus 1) with the axis direction as an attachment-and-detachment direction. The adjuster (e.g., the adjusting screw 48) is installed to be manually operable from a front side in an attachment direction with respect to the belt attached to the body of the image forming apparatus.

### Fifth Aspect

The belt device (e.g., the intermediate transfer belt device 16) according to any one of the first to fourth aspects further includes a belt deviation corrector (e.g., the belt deviation corrector 79) that corrects a belt deviation of the belt (e.g., the intermediate transfer belt 17) in the axis direction by inclining the tension roller (e.g., the tension roller 24) with respect to the axis direction.

### Sixth Aspect

The belt device (e.g., the intermediate transfer belt device 16) according to any one of the first to fifth aspects further includes a detector (e.g., the belt deviation detection sensor 51) that detects a deviation amount of the belt (e.g., the intermediate transfer belt 17) in the axis direction. The slide plate (e.g., the slide plate 42) is automatically slid according to a detection result of the detector.

### Seventh Aspect

An image forming apparatus (e.g., the image forming apparatus 1) includes the belt device (e.g., the intermediate transfer belt device 16) according to any one of the first to sixth aspects.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A belt device comprising:
a belt;
a relay;
multiple rollers including:
a drive roller to rotate to cause the belt to travel;
a tension roller to apply tension to the belt, the belt stretched between the drive roller and the tension roller; and
a backup roller:
rotatably supported by the relay; and
contacting an inner circumferential surface of the belt at a contact position;
a housing supporting both ends of each of the multiple rollers in an axial direction of the multiple rollers;
a slide plate:
held by the housing;
holding and fixing the relay at a fix position in a slide direction orthogonal to the axial direction; and
slidable, in the slide direction, to shift the contact position in the slide direction; and
an adjuster to adjust the fix position of the relay in the slide direction.

2. The belt device according to claim 1, further comprising circuitry configured to control the multiple rollers,
wherein the multiple rollers further include multiple transfer rollers to transfer images to the belt,
wherein the circuitry is configured to:
cause all the multiple transfer rollers to contact the inner circumferential surface of the belt; and
drive the drive roller to cause the belt to travel, to perform a first mode, wherein the circuitry is configured to:
cause at least one of the multiple transfer rollers to be separated from the inner circumferential surface of the belt;
cause the multiple transfer rollers other than the at least one of the multiple transfer rollers to contact the inner circumferential surface of the belt; and
drive the drive roller to cause the belt to travel, to perform a second mode, and
wherein the circuitry is configured to:
switch between the first mode and the second mode; and
cause the slide plate to slide in response to a switch between the first mode and the second mode.

3. The belt device according to claim 2,
wherein the multiple rollers include:
the tension roller;
the backup roller; and
the at least one of the multiple transfer rollers, and
are arranged in this order along a travel direction of the belt.

4. The belt device according to claim 1, further comprising a belt deviation corrector to incline the tension roller with respect to the axial direction to correct a deviation of the belt in the axial direction.

5. The belt device according to claim 2, further comprising a detector to detect an amount of deviation of the belt in the axial direction,
wherein the circuitry is further configured to cause the slide plate to slide in the slide direction according to the amount of deviation detected by the detector.

6. An image forming apparatus comprising:
an apparatus body; and
the belt device according to claim 1 attachable to and detachable from the apparatus body in the axial direction,
wherein the adjuster includes a screw, and
wherein the housing has an opening through which the screw is operable in the axial direction.
